(19) United States
(12) Patent Application Publication
(10) Pub. No.: US 2023/0245584 A1
(43) Pub. Date: Aug. 3, 2023

(54) HIGH FIDELITY, REAL-TIME OBJECT BODY STATE GENERATOR WITH DATA-DRIVEN MODELING

(71) Applicant: Microsoft Technology Licensing, LLC, Redmond, WA (US)

(72) Inventors: Fabio Raffaele CROCE, Kirkland, WA (US); Daniel Forrest HIGGINS, Sammamish, WA (US)

(73) Assignee: Microsoft Technology Licensing, LLC, Redmond, WA (US)

(21) Appl. No.: 17/852,935

(22) Filed: Jun. 29, 2022

Related U.S. Application Data
(60) Provisional application No. 63/305,529, filed on Feb. 1, 2022.

(51) Int. Cl. G09B 9/12

(52) U.S. Cl. CPC G09B 9/12

(57) ABSTRACT

To meet the stringent requirements on simulating motion of an object, a body state of the object needs to be processed in real time while minimizing an error of deviating from the trajectory and time as specified, using limited computing resources. The present disclosure simulates physical aspects of an object in motion by generating a rigid body model that includes external force data and data representing the object. The simulator determines a body state of the object with specific velocity, altitude, and heading at a specific time-tick in real-time. The simulator determines forces applied to the object to move the object and update the rigid model in the real-time process iterations. The disclosed technology uses non-linear inversion dynamics controllers to compute the body forces for following a prescribed trajectory and a rigid body model solver with advanced integration techniques providing low-latency, accuracy, and integrity of linear and rotational body states.

### CROSS-REFERENCE TO RELATED APPLICATIONS

This application claims priority to and the benefit of U.S. Provisional Patent Application No. 63/305,529, filed on Feb. 1, 2022, the disclosure of which is hereby incorporated herein by reference in its entirety.

### BACKGROUND

Systems for simulating movement of objects have become widely used both for consumer entertainment and for professional uses. For example, some video games for consumers simulate a flight of an aircraft by rendering a three-dimensional space. Some other flight simulator systems are available for training pilots in professional settings with enhanced features. While these systems provide at least near real-time motion of the object (e.g., an aircraft) in motion by periodically updating a display of the object, differences arise from accuracy in rendering positions and directions over time. There are tradeoffs at least between accuracy of determining motion of the object and computing resources needed to achieve at least the near real-time processing. As will be discussed further below, determining and updating movement (e.g., positioning and directions) of an object is a critical task in simulating motion of the object. Accordingly there has been a need to improve accuracy while also enabling real-time processing of movement of objects.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

As described further herein, there are several challenges for simulating movement of objects. Definition of rigid body, local and global positioning, incorporating impacts of external force into the movement, and errors caused by estimating a trajectory based on interpolation.

The present disclosure relates to simulating movement of an object (e.g., a rigid body) along a trajectory as specified by input. For example, the object includes an aircraft, a car, and the like. In particular, the disclosed technology receives customer data that is associated with an object. For example, the customer data includes a mass, an inertia tensor, and force/moment co-efficient associated with a particular model of an aircraft. The disclosed technology generates a rigid body model based on the customer data. The rigid body model includes a combination of three rotational data based on Euler angles (e.g., 312 Intrinsic Euler) and three translational data (e.g., x, y, and z) which together compose a Six Degrees of Freedom dynamics system with inertial properties. The rigid body includes customizable external force (e.g., Newton-Euler Body Equations of Motion). The rigid body further indicates a constant inertial tensor for constant inversion calculation.

The present disclosure receives input command (e.g., a velocity of an object, an altitude, heading, and time tick at a particular time (e.g., i-th time tick). Based on input command, the disclosed technology determines position, velocity, and acceleration of the object (e.g., the aircraft) at the time-tick. In particular, a tracking controller, based on nonlinear inversion dynamics (NDI) formulation, generates an angle of attack (AoA), sideslip, roll data, and the body forces (thrust, lift, drag, and local weight) of a rigid body based on a set of input velocity, altitude, and heading of the rigid body. A “slow rotational dynamics” NDI controller generates angular rate commands (e.g., Angular velocities P, R, Q) based on the AoA, the sideslip, and roll data. A “fast rotation dynamics” NDI controller generates moment commands (e.g., Roll, Pitch, and Yaw) based on the angular rate commands. In combination of the moment commands with the thrust, the disclosed technology determines a body state at the time-tick. The body state includes a position, a velocity, and acceleration of the object (e.g., an aircraft) at the specified time.

In particular, the disclosed technology includes a real-time strategy (RTS) for formulating rotation using the 312 Intrinsic Euler as the present disclosure converts traditional reference systems and angles into the 312 Intrinsic Euler. The disclosed technology uses an Equations of Motion (EOM) expressed for a body frame, defining forces and inertia and quaternion orientation. In aspects, coordinates associated with RTS may be based on, but not limited to, a Y forward, Z up coordinate system.

In describing the present disclosure, the term “physics” of an object refers to physical aspects of the object including motion dynamics of the object and effects of external forces (e.g., wind) upon the object. Physical aspects of an object may include but not limited to position, velocity, acceleration, altitude information, angular rate, moment, and object body forces.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system implementing a physics simulator accordance with aspects of the present disclosure.

FIG. 2 illustrates an overview of an example rigid body data model in accordance with aspects of the present disclosure.

FIG. 3 illustrates an overview of an example body data model including rotation and rigid body data in accordance with aspects of the present disclosure.

FIG. 4 illustrates an example method for iterative methods for approximating body data in accordance with aspects of the present disclosure.

FIG. 5 illustrates an example customer data in accordance with aspects of the present disclosure.

FIG. 6 illustrates an example method for simulating physics of an object in accordance with aspects of the present disclosure.

FIG. 7 is a block diagram illustrating example physical components of a computing device with which aspects of the disclosure may be practiced.

FIG. 8A is a simplified diagram of a mobile computing device with which aspects of the present disclosure may be practiced.

FIG. 8B is another simplified block diagram of a mobile computing device with which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

This Detailed Description section of Specification references the following document as an Appendix: “Mathematics of the Physics Engine.”

The present disclosure relates to simulating movement of an object (e.g., a rigid body) along a trajectory as specified by input. For example, the object includes an aircraft, a car, and the like. In particular, the disclosed technology generates a rigid body model based on sets of customer data that represent the object. The customer data may include a set of exemplary data associated with a type of an object, including a mass, an inertia tensor, and force/moment co-efficient associated with the type of the object. For example, a type object as represented by the customer data may be a particular model of an aircraft (e.g., Airbus A320). In aspects, the rigid body model includes a combination of three rotational data of the object expressed in Euler angles (e.g., 312 Intrinsic Euler) and three translational data of the object (e.g., x, y, z) composing a Six Degrees of Freedom dynamics system with inertial properties associated with the object. In aspects, the rigid body data accommodate data that represent customizable external force (e.g., Newton-Euler Body Equations of Motion). The rigid body model further indicates a constant inertial tensor for constant inversion calculation.

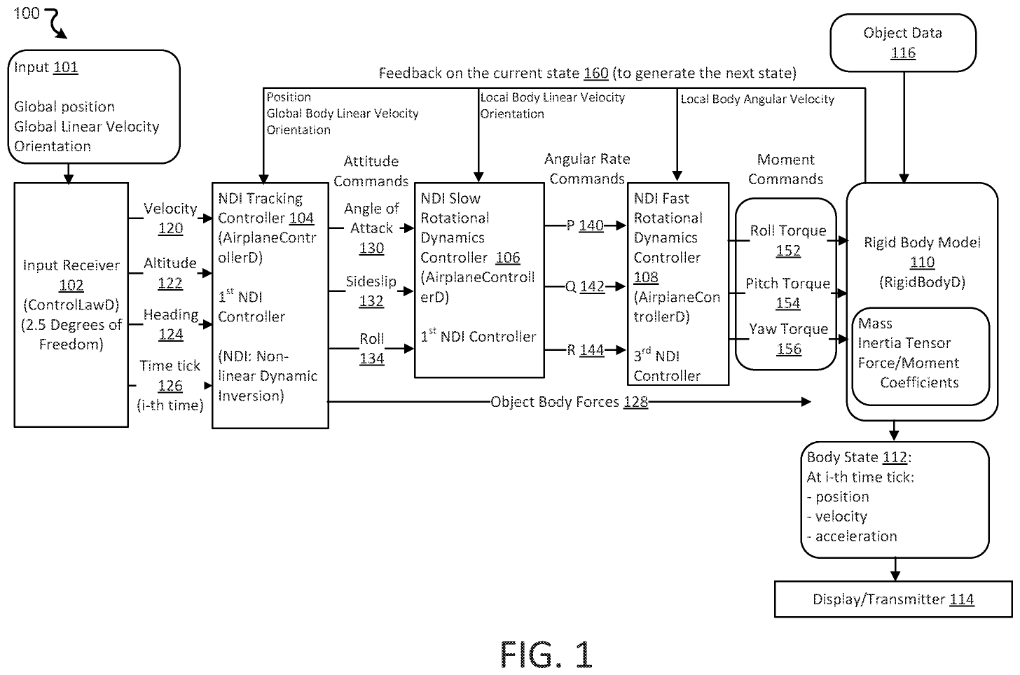

FIG. 1 illustrates an overview of an example physics simulation system 100 in which a motion of a three-dimensional object may be implemented in accordance with the aspects of the present disclosure. The example physics simulation system 100 includes input 101, an input receiver 102, an NDI tracking controller 104, an NDI slow rotational dynamics controller 106, an NDI fast rotational dynamics controller 108, a rigid body model 110, and a display/transmitter 114. In aspects, input 101 includes global position of the object, global linear velocity of the object, and orientation of the object.

In aspects, the input receiver 102 receives input data associated with simulating physical aspects of an object.

In aspects, the input receiver 102 (ControlLawD) may receive input data from an artificial intelligence processor that generates a trajectory data based on a predefined and/or a predicted set of data for simulating a motion of the object. Additionally, or alternatively, the input receiver 102 may receive input data as a command for generating a body state at a specific time-tick. In aspects, the input receiver 102 provides data including a velocity 120, an altitude 122, a heading 124 of the object, and a time-tick 126. The velocity may represent a linear velocity of the object (e.g., an aircraft flying at Mach 2.0). The altitude 122 may indicate an altitude of the flying object at a particular time (e.g., at 10,000 meters). The heading 124 may indicate a heading direction of the object (e.g., North). The time-tick 126 specifies a time tick (e.g., a time instance and/or i-th time) of the physical aspects (e.g., physics) of the object in motion. In aspects, an interval of the time-tick may be 1/30 second (e.g., thirty time ticks per second). The example physics simulation system 100 may generate a body state of an object for a given time-tick based on a given set of the velocity 120, the altitude 122, the heading 124 and the current state of the rigid body model 110.

The NDI tracking controller 104 (AirplaneControllerD) determines attitude commands associated with the object based on a combination of input, the velocity 120, the altitude, the heading 124, and the time-tick 125. In aspects, the attitude commands as output includes an angle of attack (AoA), a sideslip 132, a roll 134, and object body forces (including thrust, lift, drag and local weight) 128 of the object (e.g., the aircraft). The object body forces may be in a vector expression. In aspects, the NDI tracking controller 104 is based on a non-linear dynamic inversion (NDI) of data.

The NDI slow rotational dynamics controller 106 (AirplaneControllerD) determines a set of angular rate commands (e.g., P 140, Q 142, and R 144) based on the given angle of attack, sideslip and roll commands. Processing by the NDI slow rotational dynamics controller 106 includes a non-linear dynamic inversion (NDI) of data.

The NDI fast rotational dynamics controller 108 (AirplaneControllerD) determines moment commands of the object in motion based on the received angular rate commands (e.g., P 140, Q 142, R 144). The moment commands may include a roll torque 152, a pitch torque 154, and a yaw torque 156 applied to the flying object. Processing by the NDI fast rotational dynamics controller 108 includes a non-linear dynamic inversion (NDI) of data.

The rigid body model 110 (RigidBodyD) represents physical characteristics of the object and its instantaneous dynamics conditions (e.g., states). In aspects, the rigid body model 110 includes a mass of the object, an inertia tensor of the object, force/moment vectors associated with the object.

In aspects, a combination of the NDI tracking controller 104, the NDI slow rotational dynamics controller 106, and the NDI fast rotational dynamics controller 108 determines forces applied to the object for determining an updated body date of the object. In some traditional systems, a controller system that determines external forces may be distinct from a system that models a rigid body of the object. The present disclosure integrates the combination of three controllers (e.g., the NDI tracking controller 104, the NDI slow rotational dynamics controller 106, and the NDI fast rotational dynamics controller 108) with the rigid body model 110 for determining a body state at a specified time based on the time-tick.

The body state 112 represents output physics data associated with the object at a time as specified as the i-th time tick. In aspects, the body state 112 indicates a position of the object, a velocity of the object, and an acceleration of the object at the specified time. In aspects, an interval between two time ticks may be 1/30 seconds.

The display/transmitter 114 displays and/or transmits the body state 112 of the object. In aspects, the display/transmitter 114 displays and/or transmits the body state 112 in numerical expressions and/or graphs. In some other aspects, the display/transmitter 114 displays and/or transmits the object (e.g., the aircraft) in a three-dimensional graphics that represents the body state. In aspects, the display/transmitter 114 transmits the body state 112 to another display (not shown) or a database over a network (not shown) for storage.

In aspects, the system 100 may be implemented as in-core, real time simulator, without relying upon data from external computational resources in iteratively determining body states of the object according to the rigid body model. The system 100 may iteratively determine body states based on a time-tick that is incremented as input without interpolating data. Some traditional systems interpolated body states based on a trajectory, which often result in accumulating error in body states as time lapses and the object moves. The present disclosure determines a particular body state that is associated with a time-tick as specified, thereby minimizing errors caused by interpolation in the traditional systems.

As will be appreciated, the various methods, devices, applications, features, etc., described with respect to FIG. 1 are not intended to limit the system 100 to being performed by the particular hardware and/or software described. Accordingly, additional controller configurations may be used to practice the methods and systems herein and/or features and applications described may be excluded without departing from the methods and systems disclosed herein.

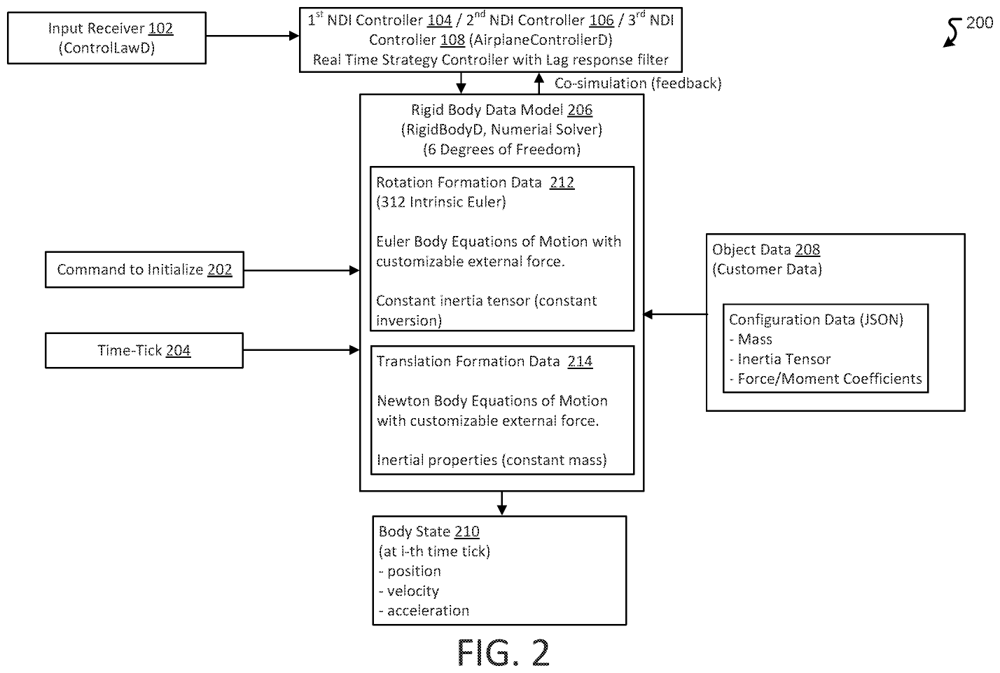

FIG. 2 illustrates an overview of an example rigid data model in accordance with the present disclosure. As illustrated, a system 200 includes a rigid body data model 206. The rigid body data model 206 receives a command to initialize 202 and a time-tick 204. Receiving the command to initialize causes the rigid body data model 206 to initialize itself by resetting data in the rigid body data model 206. In aspects, the rigid body data model 206 (RigidBodyD) is a numerical solver including a rotation formation data 212 and translation formation data 214. In aspects, the rotation formation data 212 use the 312-intrinsic Euler for determining rotational data of the object using unity quatrain Euler angles. The translation formation data 214 is represented based on three linear states. The combination of the rotation formation data 212 and the translation formation data 214 form the six-degrees of freedom system. In aspects, the rigid body data model 206 works in co-simulation with the AirplaneControllerD (e.g., a combination of the NDI tracking Controller 104, the NDI slow rotational dynamics controller 106, and the NDI fast rotational dynamics controller 108 as shown in FIG. 1) to determine at each tick the proper forces and moments which need to be applied to the rigid body to follow the trajectory from input received by the input receiver 102. In aspects, these forces and moments include a lag response filter for dynamic response of control interfaces, thereby improving process performance and generalizing modelling of the controller from object data that are specific to a particular type of object (e.g., generalizing from a rigid body model that is specific to aircraft).

The rigid body data model 206 determines a body state of the object at a specified time-tick (e.g., at i-th time tick). The body state 210 may include a position of the object, a velocity of the object, and an acceleration of the object.

In aspects, the disclosed technology receives an object data 208 for generating the rigid body data model 206. The object data 208 (e.g., customer data) includes a set of configuration data that describes physical characteristics of the object. For example, the set of configuration data may include a mass information associated with the object (e.g., the aircraft), an inertia tensor of the object, and one or more coefficients associated with an external force and/or moment upon the object. In some aspects, the configuration data may be expressed using Java Script Object Notation. In the disclosed technology includes force/moment coefficients as a part of the object data 208.

In aspects, the rigid body data model 206 includes a set of inertia properties of the object. The rigid body data model 206 may further includes the Newton-Euler Body Equations of Motion (EOM) with additional parameters that represent a customizable external force onto the object. The rigid body data model 206 may include conversion of data between the Newtonian reference system and the Euler reference system. In aspects, the rigid body data model 206 maintains a value of inertia tensor at a predetermined constant value for maintaining constant inversion to reduce computational steps needed to determine an updated body state as affected by forces.

In some aspects, the object data 208 includes data that represent the integral total effect of the moment used for rotating the object, without data that are specific to a particular type of object (e.g., surface deflection data of an aircraft).

As will be appreciated, the various methods, devices, applications, features, etc., described with respect to FIG. 2 are not intended to limit the system 200 to being performed by the particular hardware and/or software described. Accordingly, additional controller configurations may be used to practice the methods and systems herein and/or features and applications described may be excluded without departing from the methods and systems disclosed herein.

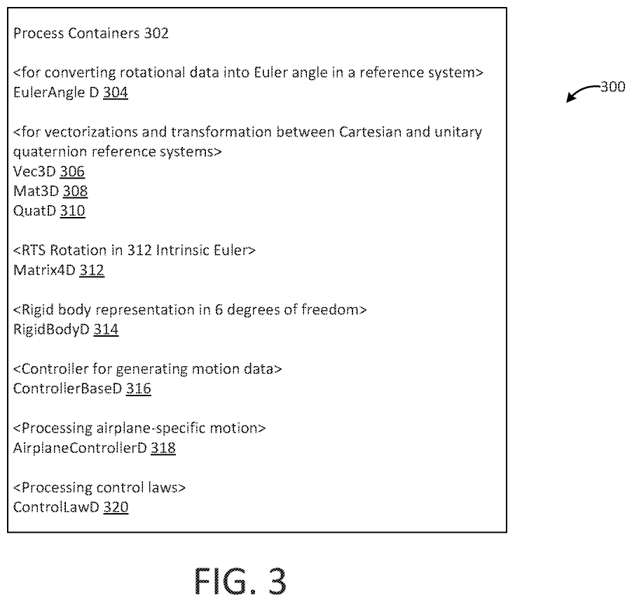

FIG. 3 illustrates an overview of an example process containers in accordance with the present disclosure. As illustrated, a list of process containers 300 includes a plurality of containers for processing data for collectively determining a body state of an object based on a set of specific conditions at a specific time.

EulerAngleD 304 converts rotational data into Euler angles in a reference system.

Containers Vec3D 306, Mat3D 308, and QuatD 310 collectively generate vectors and transform data between the Cartesian and unitary quaternion reference systems.

RigidBodyD 314 (e.g., the rigid body model 110 as shown in FIG. 1) represents a rigid body associated with the object (e.g., an aircraft) in six degrees of freedom and rotational information in quaternion.

ControllerBaseD 316 (e.g., the base framework as shown in FIG. 1) executes as a base controller framework for interfacing the rigid body model 110 with the three NDI controllers (e.g., the NDI tracking Controller 104, the NDI slow rotational dynamics controller 106, and the NDI fast rotational dynamics controller 108 as shown in FIG. 1) for generating motion data associated with the object.

AirplaneControllerD 318 (e.g., the three NDI controllers: the NDI tracking Controller 104, the NDI slow rotational dynamics controller 106, and the NDI fast rotational dynamics controller 108 as shown in FIG. 1) processes motion data that are specific to an airplane as an object.

ControlLawD 320 (e.g., the input receiver 102 as shown in FIG. 1) processes control laws. In aspects, the control laws may specify how to follow a trajectory and specifies forces applied to the object during its motion.

In aspects, program instruction codes used in the respective process containers 302 may be optimized for execution using specific compilers for a particular programming language (e.g., C++ programming language). The optimization may include but not limited to matrix multiplication, quaternion multiplication, exponential multiplication, and the like. In aspects, the optimized programming instruction codes helps determining forces and body states of the object at a specific time-tick in real-time.

Some traditional systems determine global positions of an object by integrating velocity in the global reference system. Both the linear and the angular velocity are related to the linear and angular momentum of the dynamic equations. The disclosed technology uses the local body reference system with a local linear and angular velocity data. The disclosed technology determines the global position of the body using rotational orientation based on quaternion. The integration processing data using the local referencing system and the translation into the global referencing system enables the disclosed technology to efficiently determine the global positions of the object.

As will be appreciated, the various methods, devices, applications, features, etc., described with respect to FIG. 3 are not intended to limit the list of process containers 300 to being performed by the particular hardware and/or software described. Accordingly, additional controller configurations may be used to practice the methods and systems herein and/or features and applications described may be excluded without departing from the methods and systems disclosed herein.

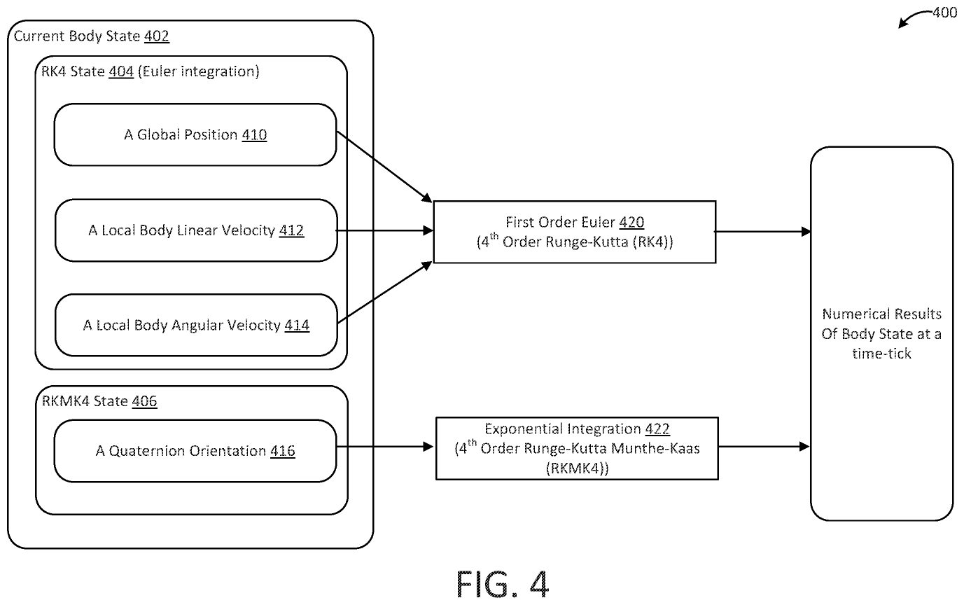

FIG. 4 illustrates an overview of an example computational processing in accordance with the present disclosure. As illustrated, a system 400 includes a set of processors for determining derivative values associated with state data of an object for determining a body state of an object based on a set of specific conditions at a specific time.

The system 400 includes a current body state 402 of an object (e.g., an aircraft) for simulating physics of the object at a specific time. The current body state 402 includes a RK4 state 404 and a RKMK4 state 406 of the object. In aspects, the RK4 state 404 includes a combination of a global position 410, a local body linear velocity 412, and a local body angular velocity 414.

The RK4 state 404 (Euler integration) collects three states of the rigid body. The global position 410 indicates a position of the body in a reference system in a global frame of reference which is inertial. The local body linear velocity 412 indicates a velocity of the body in a linear reference system attached to the body in motion (e.g., lateral x, horizontal y, vertical z). The local body angular velocity 414 indicates a velocity of the body in an angular reference system attached with the body in motion (e.g., pitch along x-axis, roll along y-axis, and yaw along z-axis).

In aspects, the RKMK4 state 406 indicates the orientation of the local body reference system with respect to the global inertial reference system. Rotational data that indicate the RKMK4 state 406 include a quaternion orientation 416. The quaternion orientation 416 indicates a rotational state of the body of the object in unit quaternions, representing spatial orientation and rotation of the body in a three-dimensional space.

In aspects, the present disclosure uses a combination of a first order Euler 420 and an exponential integration 422 for determining numerical results of a body state at a specified time (e.g., an i-th time tick). The combined operation that processes linear data and exponential data in parallel in distinct methods improves the overall performance of determining a body state in simulating physics of the object.

In particular, the disclosed technology processes the RK4 state 404 of the body based on the first order Euler 420. In some aspects, the disclosed technology uses the 4th-order Runge-Kutta (RK4) for processing the RK4 state 404 (e.g., the combination of the global position 410, the local body linear velocity 412, and the local body angular velocity 414) of the body.

In aspects, the disclosed technology processes the RKMK4 state 406 of the body based on the exponential integration 422. For example, the exponential integration 422 includes the 4th-order Runge-Kutta Munthe-Kaas (RKMK4) for processing the quaternion orientation 416 of the body. In some aspects, the operation using RKMK4 is more process intensive than an operation using RK4 because of computing exponential data. In aspects, the disclosed technology limits use of RKMK4 to the RKMK4 state 406 and use RK4 for processing the RK4 state 404, thereby optimizing computing resources needed to determine numerical results of the body state at a specific time. In aspects, the disclosed technology maintains unitary of quaternion vector for representing a rotation of the object. In aspects, the disclosed technology may use the Hamiltonian quaternion algebraic operations for processing vectors and quaternion. In some aspects, a Lie group algebraic operation may be used for computing exponential updates for RKMK4.

In aspects, the disclosed technology may determine forces in the local reference frame, not in the global reference frame and avoid needs for computing inversion of data matrices and reduce a burden in computational resources.

As will be appreciated, the various methods, devices, applications, features, etc., described with respect to FIG. 4 are not intended to limit the list of process containers 300 to being performed by the particular hardware and/or software described. Accordingly, additional controller configurations may be used to practice the methods and systems herein and/or features and applications described may be excluded without departing from the methods and systems disclosed herein.

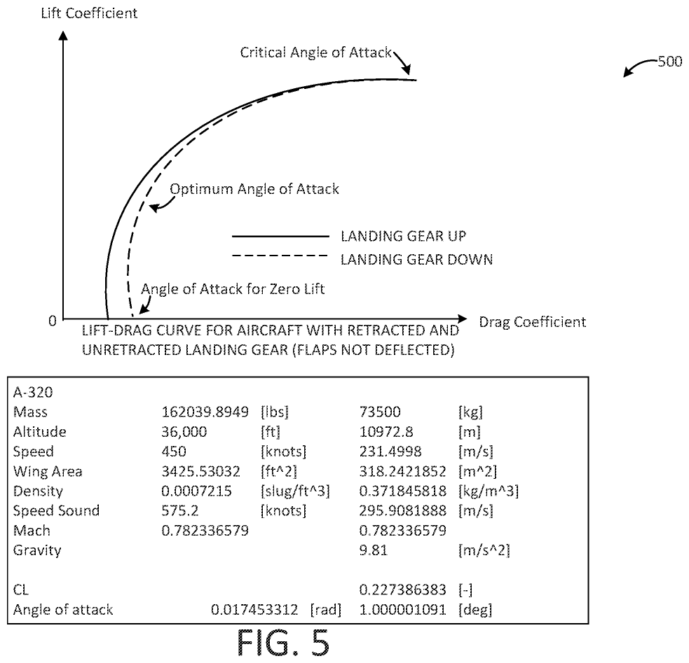

FIG. 5 illustrates an example object data (e.g., customer data) in accordance with aspects of the present disclosure. The object data 500 includes an exemplary data associated with a particular type of an aircraft (e.g., A-320 aircraft). In aspects, the object data includes data that represents a mass of the object (e.g., 73500 kg), an altitude (e.g., 10972.8 meters), a speed (e.g., 231.4998 meters per second), a wing area (e.g., 318.2421852 square meters), a density (e.g., 0.371845818 kg per square meter), a speed sound (e.g., 295.9081888 meters/second), Mach (e.g., 0.782336579), a gravity (e.g., 9.81 meters per second squared), CL (e.g., 0.227386383), and an Angle of Attack (1.000001091 degrees). In aspects, the object data 500 may further include data that represent a lift-draft curve with retracted and un-retracted landing gear (flaps not deflected). In some aspects, the object data may exclude data associated with surface deflection. In aspects, the lift-draft curve of the object may be expressed in a two-dimensional mapping between lift coefficient values and drag coefficient values. The lift-drag curve data may further indicate an angle of attack for zero lift, an optimum angle of attack, and a critical angle of attack. In aspects, the object data 500 may be specific to a particular type of an object (e.g., IL-14 aircraft, A320 aircraft, and the like). The disclosed technology in the present disclosure generates a rigid body model based on the object data and determine a body state at a specified time based on the input parameters (e.g., a velocity, an altitude, a heading, and a time-tick) by minimizing errors and computational resources needed for processing in a real time.

In aspects, the object data 500 includes data that represent three linear momentum (e.g., a set of thrust, lift, and draft, and/or a set of yaw, roll, and pitch), without data associated with surface deflection. In aspects, the present disclosure enables simulating motion of an object without processing actuator and engine dynamics logics. Accordingly, the disclosed technology determines the integral total effect of the moment associated with the object, which rotates the object. The lack of needs for processing logics associated with the actuator and engine dynamics enables generalizing the rigid body model from models that are specific to particular objects (e.g., a model that is specific to an A320 aircraft). In aspects, the disclosed technology receives and use variations of the object data 500 that represents an object for simulating physical aspects of the object.

As will be appreciated, the various methods, devices, applications, features, etc., described with respect to FIG. 5 are not intended to limit the list of process containers 300 to being performed by the particular hardware and/or software described. Accordingly, additional controller configurations may be used to practice the methods and systems herein and/or features and applications described may be excluded without departing from the methods and systems disclosed herein.

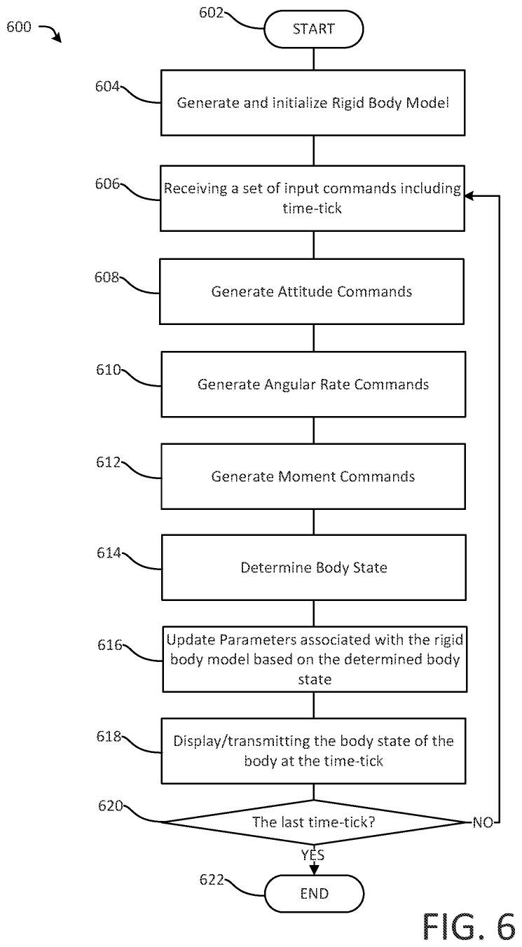

FIG. 6 illustrates an example method for simulating physics of a body of an object in accordance with aspects of the present disclosure. A general order of the operations for the method 600 is shown in FIG. 6. Generally, the method 600 begins with start operation 602 and ends with end operation 622. The method 600 may include more or fewer steps or may arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, an ASIC, an FPGA, a SOC or other hardware device.

Following start operation 602, a generate rigid body model operation 604 generates a rigid body model. In aspects, the generate rigid body model operation 604 generates the rigid body model based on an object model that represents physical characteristics of an object. For example, a rigid body model (e.g., the rigid body model 110 as shown in FIG. 1) may be based on the object data (e.g., the object data 116 as shown in FIG. 1 and/or the object data 500 as shown in FIG. 5). In aspects, the generate rigid body model operation 604 may include vectorization and/or transformation of parameter values from the object data from one reference system to another reference system to reduce needs for the overall computational resources to determine a body state of the object at a specified time. In aspects, the generate operation further includes initializing the rigid body model. Initializing the rigid body model may include setting an initial position and, if any, an initial movement of the object. In aspects, determining and updating a body state of the object may be based on the initial position and movement of the object.

A receive operation 606 receives a set of input commands including time-tick. In aspects, the input commands include a velocity, an altitude, a heading, and a time as conditions for determining a body state of the object. In aspects, the time may be expressed as a time-tick. For example, an interval of the time-tick may be 1/30 of a second.

A generate attitude commands operation 608 generates attitude commands based on the received set of input commands for determining a body state of the object. In aspects, the attitude commands (e.g., angular commands) include a combination of an angle of attack, a sideslip, and a roll associated with tracking the object in motion. In aspects, an NDI tracking controller (e.g., the NDI tracking controller 104 as shown in FIG. 1) generates the attitude commands based on a longitudinal reference system. In aspects, the generated attitude commands operation 608 further determines a thrust (e.g., the object body forces 128) associated with the body of the object. In aspects, the tracking controller determines forces needed to perform movement of the object from one position to another position according to a trajectory.

A generated angular rate commands operation 610 generates angular rate commands based on the altitude commands. In aspects, the angular rate commands include a combination of a P value, a Q value, and an R value (e.g., the P 140, the Q 142, and the R 144 as shown in FIG. 1). Additionally, or alternatively, the angular rate commands may include a roll rate, a pitch rate, and a yaw rate). In aspects, the angular rates represent the Euler angular velocity. In aspects, the generate angular rate commands operation 610 may include a non-linear dynamic inversion (NDI) operation.

A generate moment commands operation 612 generates moment commands based on the angular rate commands. In aspects, the moment commands include roll, pitch, and yaw (e.g., the roll torque 152, the pitch torque 154, and the yaw torque 156 as shown in FIG. 1) of the object. In aspects, the generate moment commands operation 612 may include an NDI operation.

A determine body state operation 614 determines a body state of the body of the object. In particular, the determine body state operation 614 uses the received body forces data (e.g., the object body forces 128 as shown in FIG. 1; the object body forces 128 may include thrust, lift, drag and weight local) and the generated moment commands on the rigid body model (e.g., the rigid body model 110 as shown in FIG. 1) of the object. The rigid body model may include a mass, an inertial tensor, and force/moment coefficient data for determining a body state at a specified time. The body state may include a position, a velocity, and an acceleration of the body of the object.

An update parameters operation 616 updates parameters associated with the rigid body model based on the determined body state. The rigid body model with the updated parameters may be used for the next iteration of determining a body state by feeding back the values to one or more controllers (e.g., the NDI tracking controller 104, the NDI slow rotational dynamics controller 106, and the NDI fast rotational dynamics controller 108 as shown in FIG. 1).

A display operation 618 displays the body state of the object at the time-tick as specified by the input. In aspects, the display operation 618 may display the body state in a list of numerical values and/or a graph, which depict the body state. In some other aspects, the display operation 618 may display the body state of the object by rendering the object (e.g., an aircraft) in a three-dimensional graphics based on the body state. Additionally, or alternatively, the display operation 618 may transmit the determined body state of the object by storing in a database and/or other devices for rendering via a network.

A decision operation 620 decides whether this is the last time-tick (and/or whether there a subsequent time-tick) for simulating physics of the object. It the present iteration is not the last time-tick and/or there is a subsequent time-tick for the simulation, the operational step proceeds to the receive operation 606 and executes the next iteration of determining a body state of the object. In aspects, the disclosed technology completes an iteration of determining and updating a body state in 1/30 of a second with a time-tick interval of the 1/30 of a second.

In aspects, the disclosed technology determines a body state for a specified time without interpolating a trajectory based on a previous computation of a body state. Rather, the disclosed technology determines values associated with a body state associated with a specified time-tick through the iteration of the method 600 as detailed above. Unlike some traditional systems with interpolating motion data based on a trajectory, the disclosed technology may provide a higher level of accuracy in a real-time (or a near real-time) operation of 1/30 of a second per iteration.

As should be appreciated, operations 602-622 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

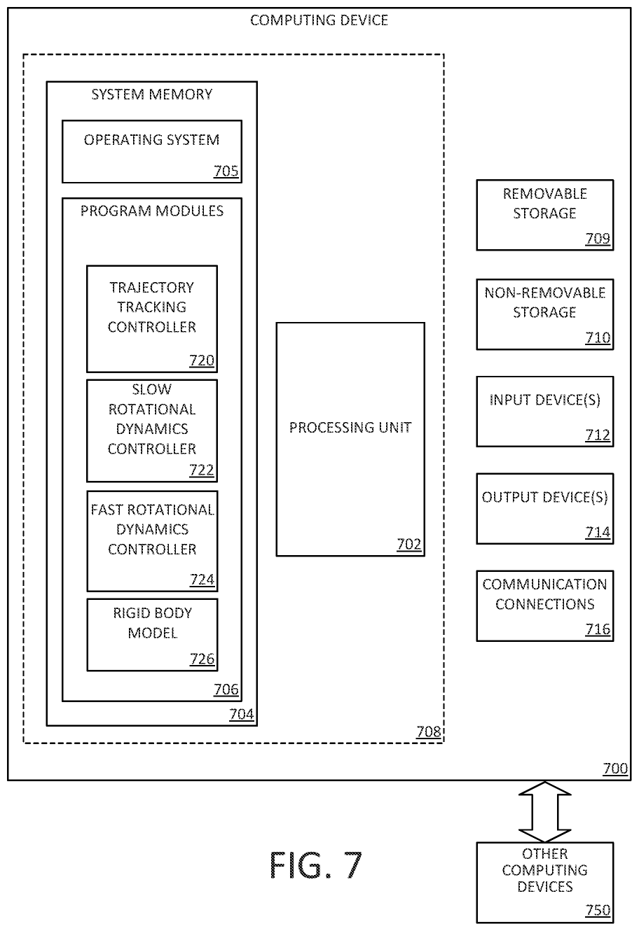

FIG. 7 is a block diagram illustrating physical components (e.g., hardware) of a computing device 700 with which aspects of the disclosure may be practiced. The computing device components described below may have computer executable instructions for implementing a rigid body model 726 on a computing device (e.g., a physics simulation system 100), including computer executable instructions for a trajectory tracking controller 720 (e.g., the NDI tracking controller 104 as shown in FIG. 1), a slow rotational controller (e.g., the NDI slow rotational dynamics controller 106 as shown in FIG. 1), a fast rotational dynamics controller (e.g., the NDI fast rotational dynamics controller 108 as shown in FIG. 1), and the rigid body model 726 (the rigid body model 110 as shown in FIG. 1), and the like, that can be executed to implement the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running the physics simulator.

The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., the trajectory tracking controller 720, the slow rotational dynamics controller 722, the fast rotational dynamics controller 724, and a rigid body model 726) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

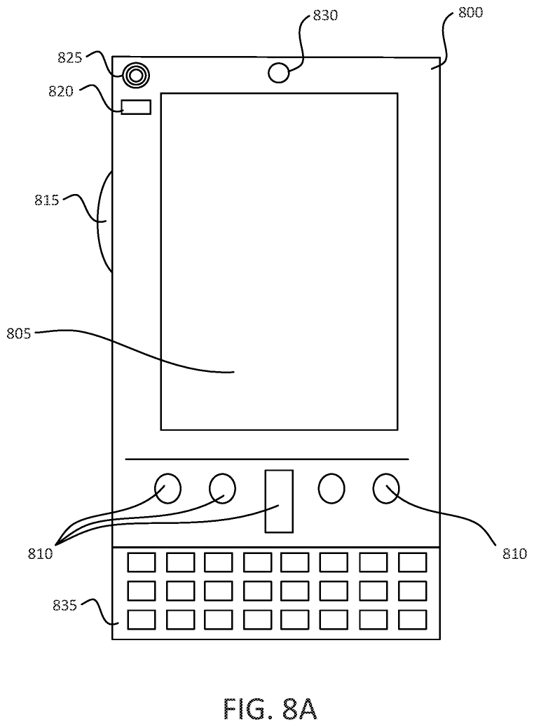

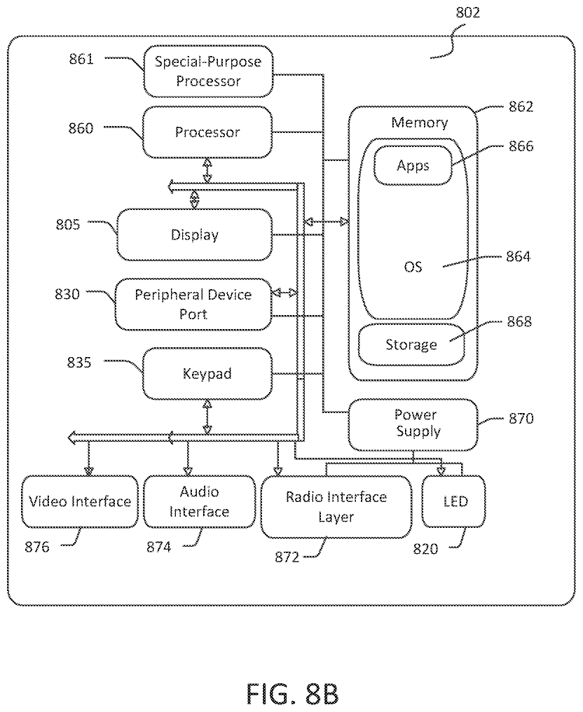

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications. In some aspects, the system 802 is integrated as a computing device, such as an integrated personal digital assistant (PDA) and wireless phone.

One or more application programs 866 may be loaded into the memory 862 and run on or in association with the operating system 864. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the instructions for implementing the physics simulator.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 825 (e.g., audio transducer 825 illustrated in FIG. 8A). In the illustrated embodiment, the visual indicator 820 is a light emitting diode (LED) and the audio transducer 825 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 8A and 8B are described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for simulating physics of an object, according to at least the examples provided in the sections below. The system comprises a processor; and a memory storing instructions that, when executed by the processor, cause the system for simulating motion of an object to execute a method comprising: generating, based on object data of the object, a rigid body model associated with the object; receiving a set of input commands over time, wherein an input commands in the set of input commands is associated with a time-tick, the time-tick increments over time; generating, based on the set of input commands, a set of moment commands over time; determining, based on a combination of the rigid body model and the set of moment commands, a body state of the object at the time-tick; and causing an iterative display of the body state of the object at the time-tick incrementing over time. The set of input commands further comprises a velocity of the object at the time-tick; an altitude of the object at the time-tick; and a heading of the object at the time-tick. The rigid body model further comprises rigid body data based on six degrees of freedom; and rotation formulation data based on 312-intrinsic Euler. The determined body state further comprises a position of the object at the time-tick; a velocity of the object at the time-tick; and an acceleration of the object at the time-tick. The determining the set of moment commands uses a combination of a first order Euler based on 4th-order Runge-Kutta on linear state data and an exponential integration based on the 4th-order Runge-Kutta Munthe-Kaas for rotational state data, the linear state data includes at least a global position, a local body linear velocity, and a local body angular velocity of the object, and the rotational state data indicates a quaternion orientation of the object. The processor further causes the system to execute a method comprising determining, based on the received set of input commands including the incremented time-tick, a set of attitude commands; determining, based on the set of attitude commands, a set of angular rate commands; and determining, based on the set of angular rate commands, the set of moment commands. The object data includes at least a type of the object, a mass of the object, an inertia tensor of the object, or a moment co-efficient associated with the type of the object. The processor further causes the system to execute a method comprising iteratively updating, based on the determined body state, a parameter associated with the rigid body model. The processor further causes the system to execute a method comprising: transmitting the body state of the object at the incremented time-tick.

Another aspect of the technology relates to a computer-implemented method for simulating motion of an object. The method comprises receiving a set of input commands over time, wherein an input commands in the set of input commands is associated with a time-tick, the time-tick increments over time; generating, based on the set of input commands, a set of moment commands over time; determining, based on a combination of a rigid body model and the set of moment commands, a body state of the object at the time-tick; and causing an iterative display of the body state of the object at the time-tick incrementing over time. The set of input commands further comprises a velocity of the object at the time-tick; an altitude of the object at the time-tick; and a heading of the object at the time-tick. The method further comprises generating, based on object data of the object, the rigid body model associated with the object, wherein the rigid body model includes rigid body data based on six degrees of freedom, and rotation formulation data based on 312-intrinsic Euler, and the object data includes at least: a type of the object, a mass of the object, an inertia tensor of the object, or a moment co-efficient associated with the type of the object. The determined body state includes a position of the object at the time-tick, a velocity of the object at the time-tick, and an acceleration of the object at the time-tick. The determining the set of moment commands uses a combination of a first order Euler based on 4th-order Runge-Kutta on linear state data and an exponential integration based on the 4th-order Runge-Kutta Munthe-Kaas for rotational state data, the linear state data include at least a global position, a local body linear velocity, and a local body angular velocity of the object, and the rotational state data indicate a quaternion orientation of the object. The method further comprises determining, based on the received set of input commands including the incremented time-tick, a set of attitude commands; determining, based on the set of attitude commands, a set of angular rate commands; and determining, based on the set of angular rate commands, the set of moment commands.

In still further aspects, the technology relates to a device for simulating motion of an object. The device comprises a processor configured to execute a method comprising: generating, based on object data of the object, a rigid body model associated with the object, wherein the object includes an aircraft; receiving a set of input commands over time, wherein an input commands in the set of input commands is associated with a time-tick, the time-tick increments over time; determining, based on the received set of input commands including the incremented time-tick, a set of attitude commands; determining, based on the set of attitude commands, a set of angular rate commands; determining, based on the set of angular rate commands, a set of moment commands; determining, based on a combination of the rigid body model and the set of moment commands, a body state of the object at the time-tick; and causing an iterative display of the body state of the object at the time-tick incrementing over time. The set of input commands further comprises a velocity of the object at the time-tick; an altitude of the object at the time-tick; and a heading of the object at the time-tick. The rigid body model further comprises rigid body data based on six degrees of freedom; and rotation formulation data based on 312-intrinsic Euler. The determined body state comprises a position of the object at the time-tick; a velocity of the object at the time-tick; and an acceleration of the object at the time-tick. The determining the set of moment commands uses a combination of a first order Euler based on 4th-order Runge-Kutta on linear state data and an exponential integration based on the 4th-order Runge-Kutta Munthe-Kaas for rotational state data, the linear state data include at least a global position, a local body linear velocity, and a local body angular velocity of the object, and the rotational state data indicate a quaternion orientation of the object.

Any of the one or more above aspects in combination with any other of the one or more aspect. Any of the one or more aspects as described herein.

What is claimed is:

1. A system comprising:
a processor; and
a memory storing instructions that, when executed by the processor, cause the system for simulating motion of an object to execute a method comprising:
generating, based on object data of the object, a rigid body model associated with the object;
receiving a set of input commands over time, wherein an input commands in the set of input commands is associated with a time-tick, the time-tick increments over time;
generating, based on the set of input commands, a set of moment commands over time;
determining, based on a combination of the rigid body model and the set of moment commands, a body state of the object at the time-tick; and
causing an iterative display of the body state of the object at the time-tick incrementing over time.

2. The system according to claim 1, wherein the set of input commands further comprises:
a velocity of the object at the time-tick;
an altitude of the object at the time-tick; and
a heading of the object at the time-tick.

3. The system according to claim 1, wherein the rigid body model further comprises:
rigid body data based on six degrees of freedom; and
rotation formulation data based on 312-intrinsic Euler.

4. The system according to claim 1, wherein the determined body state further comprises:
a position of the object at the time-tick;
a velocity of the object at the time-tick; and
an acceleration of the object at the time-tick.

5. The system according to claim 1, wherein the determining the set of moment commands uses a combination of a first order Euler based on 4th-order Runge-Kutta on linear state data and an exponential integration based on the 4th-order Runge-Kutta Munthe-Kaas for rotational state data, the linear state data includes at least a global position, a local body linear velocity, and a local body angular velocity of the object, and the rotational state data indicates a quaternion orientation of the object.

6. The system according to claim 1, the processor further causes the system to execute a method comprising:
determining, based on the received set of input commands including the incremented time-tick, a set of attitude commands;
determining, based on the set of attitude commands, a set of angular rate commands; and
determining, based on the set of angular rate commands, the set of moment commands.

7. The system according to claim 1, wherein the object data includes at least:
a type of the object,
a mass of the object,
an inertia tensor of the object, or
a moment co-efficient associated with the type of the object.

8. The system according to claim 1, the processor further causes the system to execute a method comprising:
iteratively updating, based on the determined body state, a parameter associated with the rigid body model.

9. The system according to claim 1, the processor further causes the system to execute a method comprising:
transmitting the body state of the object at the incremented time-tick.

10. A computer-implemented method for simulating motion of an object, the method comprising:
receiving a set of input commands over time, wherein an input commands in the set of input commands is associated with a time-tick, the time-tick increments over time;
generating, based on the set of input commands, a set of moment commands over time;
determining, based on a combination of a rigid body model and the set of moment commands, a body state of the object at the time-tick; and
causing an iterative display of the body state of the object at the time-tick incrementing over time.

11. The computer-implemented method of claim 10, wherein the set of input commands further comprises:
a velocity of the object at the time-tick;
an altitude of the object at the time-tick; and
a heading of the object at the time-tick.

12. The computer-implemented method of claim 10, the method further comprising:
generating, based on object data of the object, the rigid body model associated with the object,
wherein the rigid body model includes:
rigid body data based on six degrees of freedom, and
rotation formulation data based on 312-intrinsic Euler, and
the object data includes at least:
a type of the object,
a mass of the object,
an inertia tensor of the object, or
a moment co-efficient associated with the type of the object.

13. The computer-implemented method according to claim 10, wherein the determined body state includes:
a position of the object at the time-tick,
a velocity of the object at the time-tick, and
an acceleration of the object at the time-tick.

14. The computer-implemented method according to claim 10,
wherein the determining the set of moment commands uses a combination of a first order Euler based on 4th-order Runge-Kutta on linear state data and an exponential integration based on the 4th-order Runge-Kutta Munthe-Kaas for rotational state data,
the linear state data include at least a global position, a local body linear velocity, and a local body angular velocity of the object, and
the rotational state data indicate a quaternion orientation of the object.

15. The computer-implemented method according to claim 10, the method further comprises:
determining, based on the received set of input commands including the incremented time-tick, a set of attitude commands;
determining, based on the set of attitude commands, a set of angular rate commands; and
determining, based on the set of angular rate commands, the set of moment commands.

16. A device for simulating motion of an object, the device comprises a processor configured to execute a method comprising:
generating, based on object data of the object, a rigid body model associated with the object, wherein the object includes an aircraft;
receiving a set of input commands over time, wherein an input commands in the set of input commands is associated with a time-tick, the time-tick increments over time;
determining, based on the received set of input commands including the incremented time-tick, a set of attitude commands;
determining, based on the set of attitude commands, a set of angular rate commands;
determining, based on the set of angular rate commands, a set of moment commands;
determining, based on a combination of the rigid body model and the set of moment commands, a body state of the object at the time-tick; and
causing an iterative display of the body state of the object at the time-tick incrementing over time.

17. The device according to claim 16, wherein the set of input commands further comprises:
a velocity of the object at the time-tick;
an altitude of the object at the time-tick; and
a heading of the object at the time-tick.

18. The device according to claim 16, wherein the rigid body model further comprises:
rigid body data based on six degrees of freedom; and
rotation formulation data based on 312-intrinsic Euler.

19. The device according to claim 16, wherein the determined body state comprises:
a position of the object at the time-tick;
a velocity of the object at the time-tick; and
an acceleration of the object at the time-tick.

20. The device according to claim 16,
wherein the determining the set of moment commands uses a combination of a first order Euler based on 4th-order Runge-Kutta on linear state data and an exponential integration based on the 4th-order Runge-Kutta Munthe-Kaas for rotational state data,
the linear state data include at least a global position, a local body linear velocity, and a local body angular velocity of the object, and
the rotational state data indicate a quaternion orientation of the object.
